(19) United States
(12) Patent Application Publication
(10) Pub. No.: US 2016/0204919 A1
(43) Pub. Date: Jul. 14, 2016

(54) Method and Controlling Node for Controlling Radio Communication in a Cellular Network

(71) Applicant: TELEFONAKTIEBOLAGET L M ERICSSON (PUBL), Stockholm (SE)

(72) Inventors: Namir Lidian, Solna (SE); Sairamesh Nammi, Kista (SE)

(21) Appl. No.: 14/912,456

(22) PCT Filed: Dec. 4, 2013
(86) PCT No.: PCT/SE2013/051447

§ 371 Date: Feb. 17, 2016

Related U.S. Application Data
(60) Provisional application No. 61/867,641, filed on Aug. 20, 2013.

(51) Int. Cl. H04L 5/00; H04L 1/00

(52) U.S. Cl. CPC H04L 5/0048; H04L 1/0026; H04L 5/0073

(57) ABSTRACT

A method and a controlling node (700) of a cellular network, to control radio communication over a radio link used by a User Equipment, UE, to communicate radio signals with multiple radio nodes (702) serving a combined cell. The controlling node (700) receives from the UE a Channel Quality Indicator, CQI, that has been determined by the UE based on a common pilot signal transmitted by the multiple radio nodes. When it is detected that the received CQI has been determined by the UE during a time interval when one or more node-specific pilot signals were also transmitted individually by one or more of the multiple radio nodes in the combined cell, the controlling node (700) changes the received CQI to compensate for interference caused by the one or more node-specific pilot signals on the common pilot signal when received by the UE. The changed CQI is then used for evaluating the radio link. Thereby, the evaluation of the radio link is made more accurately and truthfully since the original received CQI was overly pessimistic due to the interference caused by the node-specific pilot signal(s).

### TECHNICAL FIELD

The present disclosure relates generally to a method and a controlling node of a cellular network, for controlling radio communication over a radio link used by a User Equipment, UE, to communicate radio signals with multiple radio nodes serving a combined cell in the cellular network.

### BACKGROUND

In the field of radio communication in cellular networks, the term “User Equipment, UE” is commonly used and will be used in this disclosure to represent any wireless terminal, mobile phone, tablet or device capable of radio communication including receiving downlink signals transmitted from one or more serving radio nodes and sending uplink signals to the radio node(s). Further, the term “radio node”, also commonly referred to as a base station, e-nodeB, eNB, etc., represents any node of a cellular network that can communicate uplink and downlink radio signals with UEs. The radio nodes described here may, without limitation, include so-called macro nodes and Low Power Nodes, LPNs, such as micro, pico, femto, Wifi and relay nodes, to mention some customary examples.

In recent years, different types of cellular networks for wireless communication have been developed to provide radio access for various wireless terminals in different areas. The cellular networks are constantly improved to provide better coverage and capacity to meet the demands from subscribers using services and increasingly advanced terminals, e.g. smartphones and tablets, which may require considerable amounts of bandwidth and resources for data transport in the networks. As a result, it is common to configure a network with cells of varying types and sizes, e.g. in an overlapping fashion, to provide needed capacity and flexibility depending on expected traffic intensity in different areas, the cells forming a so-called heterogeneous cellular network.

A heterogeneous cellular network may comprise hierarchically arranged nodes, including macro nodes transmitting with relatively high power and covering relatively large areas of a size in the order of kilometers, and low power nodes transmitting with relatively low power and covering areas of a size in the order of a few meters, e.g. micro, pico, femto and relay nodes, to mention some customary examples. The low power nodes may be employed together with the macro nodes in an overlapping fashion to locally provide added capacity in so-called “hot spot” areas such that multiple small areas served by such micro/pico/femto/relay nodes may be located within the area served by a macro node. The above-described heterogeneous network may be realized basically in two different ways, commonly referred to as:
1) “Co-channel deployment” where the macro node and the low power nodes cover individual cells with different cell identities, which means that a UE is served by one radio node at a time and must undergo handover between the cells when necessary to maintain adequate radio coverage, and
2) “Combined cell deployment”, where the macro node and the low power nodes cover the same common cell with a single shared cell identity, which means that a UE in the cell can basically be served by several or all radio nodes of the cell at the same time. This type of cell is hereafter called a “combined cell”. The radio nodes of such a combined cell, sometimes also called a “soft cell” or “shared cell”, can be regarded as a distributed radio node with multiple antennas at different locations in the cell.

The latter alternative of using a combined cell with multiple radio nodes has the advantage of eliminating the need for performing handover which reduces the amount of signaling and reduces the risk of dropped connection due to failed handover, among other things. Uplink radio signals, e.g. containing data, sent from the UE is received by several or all of the radio nodes which are able to process the data jointly.

The radio nodes in a combined cell send various pilot signals to enable UEs to measure the pilot signals and determine a quality-related parameter generally referred to as “Channel Quality Indicator, CQI”. In FIG. 1, a combined cell is served by a macro node 100 covering virtually the whole cell and a plurality of low power nodes 102, 104, 106 and 108 each covering a small part of the whole cell, e.g. to locally add coverage and/or capacity. A UE located somewhere in the combined cell may be connected to all or at least some of the nodes 100-108 at the same time such that these nodes receive and process uplink radio signals sent from the UE. It should be noted that a combined cell may be served basically by any number of nodes and having four serving nodes as shown in FIG. 1 is just a non-limiting illustrative example. Using multiple radio nodes to serve UEs in a combined cell is sometimes also called “spatial reuse mode”.

In this disclosure, the term “combined cell” is thus used to represent a cell being served by multiple radio nodes at the same time such that they all may receive uplink radio signals transmitted from a UE in the cell, or at least those radio nodes that are close enough to the UE to detect the UE's transmitted radio signals. The macro node 100 transmits signals with relatively high power to basically cover the whole cell, and the low power nodes 102-106 transmit signals with relatively low power to cover a small part of the combined cell, as explained above. As shown in FIG. 1, all radio nodes 100-106 transmit pilot signals “P”, commonly referred to as a “Common Pilot Channel, CPICH”, and the UE may measure the pilot signals and determine a CQI based on one or more of the pilot signals. The UE also reports the determined CQI to its serving radio node(s), which may be any of the shown radio nodes 100-106. A controlling function of the combined cell, which may be implemented in the macro node 100 or in a separate node connected to the radio nodes 100-106, is then able to evaluate a radio link used by the UE, to be used e.g. as a basis for scheduling, power regulation, handover decisions, selecting coding and modulation schemes, to mention some customary examples.

However, it is a problem that the CQI reported by the UE may sometimes be misleading, e.g. when the pilot signal P, such as CPICH, was measured by the UE at the same time as other short-lived signals were transmitted in the cell which thus happen to momentarily disturb reception of the pilot signal P. In that case, the quality of the pilot signal P as measured by the UE is low due to the disturbing and interfering signals and the UE reports a CQI that may thus be overly pessimistic since those interfering signals may not be present during signal reception in a communication session. As a result, the controlling function of the combined cell may take ill-founded and non-optimal decisions, e.g. regarding scheduling, power regulation, handover decisions, selecting coding and modulation schemes, based on a misleading CQI. For example, a robust coding or modulation scheme with low data rate may be selected even though schemes with higher data rate would be possible, or unnecessarily high transmission power may be used, or the combined cell may even appear to be unsuitable for serving the UE, due to the pessimistic CQI reported by the UE.

### SUMMARY

It is an object of embodiments described herein to address at least some of the problems and issues outlined above. It is possible to achieve this object and others by using a method and a controlling node as defined in the attached independent claims.

In this solution, it has been recognized that when a UE reports a CQI based on measurements of a common pilot signal transmitted from radio nodes of a combined cell, the reported CQI may be too “pessimistic” and misleading if the measurements were made at the same time as one or more node-specific pilot signals were also transmitted in the combined cell thus causing interference to the measured common pilot signal. Thus, it has been realized that such transmission(s) of node-specific pilot signals are a potential cause for the above-mentioned problem that the CQI reported by the UE may be misleading.

According to one aspect, a method is performed by a controlling node of a cellular network for wireless communication, to control radio communication over a radio link used by a User Equipment, UE, to communicate radio signals with multiple radio nodes serving a combined cell in the cellular network. In this method, the controlling node receives from the UE a Channel Quality Indicator, CQI, that has been determined by the UE based on a common pilot signal transmitted by the multiple radio nodes of the combined cell. The controlling node then detects that the received CQI has been determined by the UE during a time interval when one or more node-specific pilot signals were also transmitted individually by one or more of the multiple radio nodes in the combined cell. The controlling node further changes the received CQI to compensate for interference caused by the one or more node-specific pilot signals on the common pilot signal when received by the UE, and uses the changed CQI for evaluating the radio link. Thereby, the received CQI is made more truthful such that a more accurate and useful evaluation of the radio link can be achieved as compared to using the received CQI unchanged.

According to another aspect, a controlling node of a cellular network for wireless communication is arranged to control radio communication over a radio link used by a UE to communicate radio signals with multiple radio nodes serving a combined cell in the cellular network. The controlling node comprises a receiving unit which is configured to receive from the UE a CQI that has been determined by the UE based on a common pilot signal transmitted by the multiple radio nodes of the combined cell.

The controlling node also comprises a logic unit which is configured to detect that the received CQI has been determined by the UE during a time interval when one or more node-specific pilot signals were also transmitted individually by one or more of the multiple radio nodes in the combined cell. The logic unit is further configured to change the received CQI to compensate for interference caused by the one or more node-specific pilot signals on the common pilot signal when received by the UE. The controlling node further comprises an evaluating unit which is configured to use the changed CQI for evaluating the radio link.

The above method and controlling node may be configured and implemented according to different optional embodiments to accomplish further features and benefits, to be described below.

### BRIEF DESCRIPTION OF DRAWINGS

The solution will now be described in more detail by means of exemplary embodiments and with reference to the accompanying drawings, in which:

FIG. 1 illustrates a communication scenario where a UE is served by multiple radio nodes of a combined cell, according to the prior art.

FIG. 2 is a flow chart illustrating a procedure in a controlling node, according to some possible embodiments.

FIG. 3 is another flow chart illustrating an example of how a controlling node may change a received CQI, according further possible embodiments.

FIG. 4 is yet another flow chart illustrating another example of how a controlling node may change a received CQI, according to further possible embodiments.

FIG. 5 illustrates an example of how node-specific pilot signals may occur in time when the solution can be used.

FIG. 6 illustrates another example of how node-specific pilot signals may occur in time when the solution can be used.

FIG. 7 is a block diagram illustrating a controlling node in more detail when in operation, according to further possible embodiments.

FIG. 8 illustrates a heterogeneous network with multiple radio nodes serving separate cells A-C.

FIG. 9 illustrates a heterogeneous network with multiple radio nodes serving a combined cell A where the solution can be used.

FIG. 10 illustrates how a macro node and three LPNs of a combined cell may transmit the same pilot signals.

FIG. 11 illustrates how four radio nodes 1-4 of a combined cell may transmit different node-specific pilot signals, where the solution can be used.

FIG. 12 illustrates a configuration of a combined cell deployment where the solution can be used.

FIG. 13 is a signaling diagram comprising a message sequence that may be employed when the solution is used.

FIG. 14 is another flow chart illustrating another example of how a controlling node may change a received CQI, according to further possible embodiments.

### DETAILED DESCRIPTION

A solution is provided to enable usage of a more accurate and truthful CQI for evaluating a radio link used by a UE to communicate radio signals with multiple radio nodes of a combined cell, as compared to the CQI reported by a UE. Various embodiments described herein may be implemented by functionality in a controlling node of a cellular network for wireless communication, when the UE reports a CQI based on a common pilot signal transmitted from multiple radio nodes serving a combined cell. The controlling node basically operates to adjust the reported CQI to become more truthful in order to avoid the above problems. More specifically, if it is found that the common pilot signal has been measured by the UE during a time interval, or CQI determination period, when one or more node-specific pilot signals were also transmitted by one or more of the radio nodes, the controlling node adjusts the reported CQI to a “better” value than the reported one, since the node-specific pilot signals can be assumed to have interfered with the common pilot signal during the measurement. The adjusted CQI value thus compensates for the interference caused by the node-specific pilot signals which has made the determined and reported CQI overly pessimistic, which will be described in more detail below.

First, some examples of the above-mentioned node-specific pilot signals will be described. Additional pilots are useful in a combined cell in spatial reuse mode e.g. for achieving added capacity. These additional pilots may comprise node-specific demodulation pilots, commonly denoted D-CPICH, which are typically transmitted whenever any UE configured for High Speed Packet Access, HSPA, Release-12 is scheduled for data transmission, which enables the UE to measure the node-specific pilot signal and determine a value of CQI based on the measured node-specific pilot signal. However, some of these pilots may cause interference to so-called legacy UEs which may not be capable of using the pilots for determining the CQI. In this disclosure, the term “legacy UE” denotes a UE that is configured to determine CQI based on a common pilot signal specified according to HSPA Release 11 or earlier, but not to determine CQI based on a node-specific pilot signal specified according to HSPA Release 12 or later. Further, the term “non-legacy UE” denotes a UE that is configured to determine CQI based on a node-specific pilot signal specified according to HSPA Release 12 or later. Hence the legacy UEs, which thus may be referred to as “pre-12” UEs, might report a CQI which is somewhat lower, or “worse”, as compared to a CQI determined without these interfering demodulation pilots.

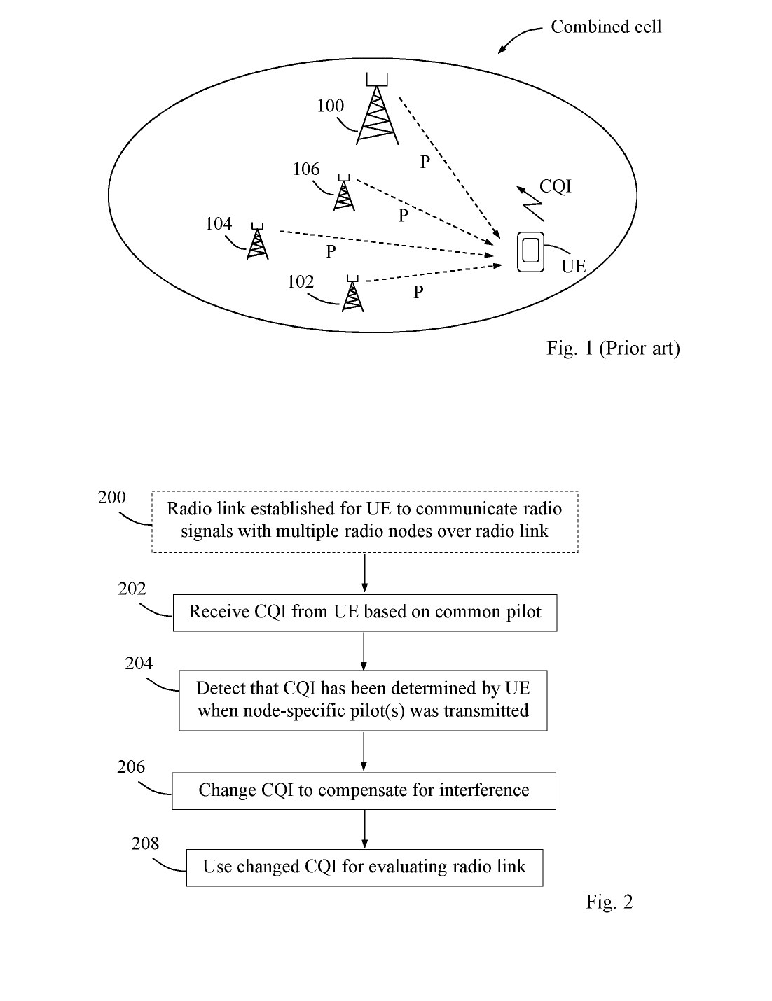

The proposed adjustment of CQI will now be explained in terms of an example of a procedure with actions performed by a controlling node of a cellular network for wireless communication, as illustrated by the flow chart in FIG. 2. A misleading, or “corrupted”, CQI that has been determined and reported by the UE can be handled by the controlling node in the following manner. The controlling node is arranged to control radio communication over a radio link used by a UE to communicate radio signals with multiple radio nodes serving a combined cell in the cellular network.

A first action 200, illustrates schematically that the radio communication is established for the UE to communicate radio signals with the multiple radio nodes. In a next action 202, the controlling node receives a CQI reported from the UE. The CQI has been determined by the UE based on a common pilot signal transmitted by the multiple radio nodes of the combined cell. The common pilot signal in this context thus corresponds to the above-described primary common pilot, P-CPICH which is the same from all nodes in the combined cell. In a possible embodiment, the UE may be a legacy UE capable of determining CQI based on the common pilot signal but not based on any node-specific pilot signal. In that case, the CQI is commonly referred to as “CQIP”.

In a further action 204, the controlling node detects that the received CQI has been determined by the UE during a time interval, which may also be called the CQI determination period, when one or more node-specific pilot signals were also transmitted individually by one or more of the multiple radio nodes in the combined cell. In a possible embodiment, the one or more node-specific pilot signals may comprise a node-specific demodulation pilot such as the above-mentioned D-CPICH. In another possible embodiment, the one or more node-specific pilot signals may be transmitted in the combined cell to enable any non-legacy UEs present in the combined cell to determine one or more node-specific CQIs based on the one or more node-specific pilot signals. In that case, the node-specific CQI is commonly referred to as “CQIF”. In further possible embodiments, the common pilot signal may comprise a Primary CPICH commonly referred to as “P-CPICH”, while the one or more node-specific pilot signals may comprise a Fractional CPICH commonly referred to as “F-CPICH”.

The controlling node then changes the received CQI, in a following action 206, to compensate for interference caused by the one or more node-specific pilot signals on the common pilot signal when received by the UE. Changing of the received CQI as of action 206 above may be performed by the controlling node according to any of two examples outlined below. In a final shown action 208, the controlling node uses the changed CQI for evaluating the radio link. In more detail, the radio link evaluation may be used as a basis for controlling the radio communication, e.g. for scheduling, power regulation, handover decisions, selecting coding and modulation schemes. The solution is not limited to any particular usage of the radio link evaluation.

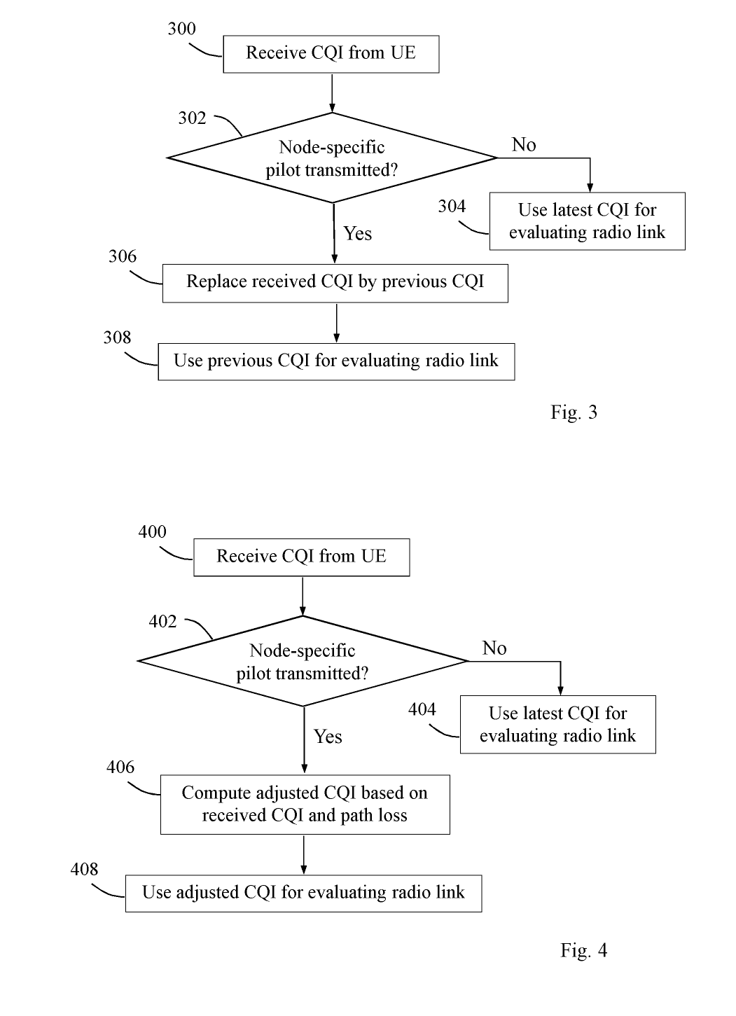

Two alternative examples will now be described of how the controlling node may operate in more detail when performing the above action 206 of changing the received CQI to compensate for the above-mentioned interference on the common pilot signal caused by the one or more node-specific pilot signals, with reference to the flow charts of FIGS. 3 and 4, respectively.

### EXAMPLE 1

This example is illustrated by the flow chart in FIG. 3 comprising actions performed by the above-described controlling node. In a first action 300, the controlling node receives a CQI reported from the UE which CQI has been determined by the UE based on a common pilot signal, basically corresponding to action 202 above. The controlling node then determines or detects in an action 302 whether any node-specific pilot signal has been transmitted individually by one or more of the radio nodes in the combined cell during the same time interval, or CQI determination period, as when the received CQI was determined by the UE. If this is not the case, the CQI received in action 300 is deemed to be accurate by not being corrupted by interference from any node-specific pilot signal and the controlling node can use the latest CQI as is for evaluating the radio link in an action 304. On the other hand, if it is detected in action 302 that one or more node-specific pilot signal were transmitted when the received CQI was determined by the UE, the controlling node changes the received CQI as follows.

In this example, changing the received CQI means that the controlling node replaces the received CQI by a previously received CQI, as shown by an action 306, wherein the UE has determined the previous CQI during a time interval when no node-specific pilot signal was transmitted in the combined cell. Another action 308 illustrates that the controlling node uses the replaced CQI for evaluating the radio link, basically corresponding to action 208 above. For example, when scheduling data packets for legacy UEs, the controlling node should check whether the UE has determined and computed CQI during periods when any node-specific demodulation pilots were transmitted. If the CQI was computed by the UE during these periods, then a previously reported CQI determined/computed by the UE when there are no demodulation pilots transmitted from any node, may be used instead according to this embodiment, since this CQI has not been impacted or corrupted by interference from any node-specific demodulation pilots like the latest received CQI as of action 300.

### EXAMPLE 2

This example is illustrated by the flow chart in FIG. 14 likewise comprising actions performed by the above-described controlling node. Actions 400-404 are the same as actions 300-304 described above which are therefore not necessary to repeat here. If it is detected in action 402 of this example that one or more node-specific pilot signal were transmitted when the received CQI was determined by the UE, the controlling node changes the received CQI as follows.

In this example, changing the received CQI comprises computing an adjusted CQI, denoted “CQI_adjusted”, based on the received CQI, denoted “CQI_R”, and further based on a path loss “PLⱼ” of each radio node j in the combined cell, as shown in an action 406, and replacing the received CQI by the adjusted CQI.

In more detail, the adjusted CQI may be computed as:

CQI_adjusted= [symbol] (G(CQI_R) dB−Σxj(PLj)dB)

where G and [symbol] are inverse functions, the summation Σ goes from j=1 to Np being the total number of radio nodes in the combined cell, and xj is a binary variable that can be 1 or 0, wherein xj is equal to 1 when the node-specific pilot signal is switched on by the radio node j during the CQI determination period and xj is equal to 0 when the node-specific pilot signal is switched off by the radio node j during the CQI determination period.

It is thus assumed that the total number of radio nodes in the combined cell is Np and CQI_R is the CQI reported by the UE. In order to calculate CQI_adjusted in the above equation, the controlling node needs to know the path loss PL from each of the radio nodes. The PL of the radio nodes may be determined in different ways as known in the art, without limitation to this embodiment, which are however outside the scope of this solution.

In further possible embodiments, the controlling node may select one of the above two example procedures 1 and 2 depending on a current speed of the UE. In these embodiments it has been realized that the procedure of example 1 can be suitable to use if the UE speed is below a certain threshold, assuming that the previous CQI has not changed much and is still valid, while the procedure of example 2 can be more suitable to use if the UE speed is above the threshold assuming that the CQI varies more rapidly due to varying location of the UE and should therefore be based on a more recent measurement. These embodiments will be described in more detail later below with reference to FIG. 14.

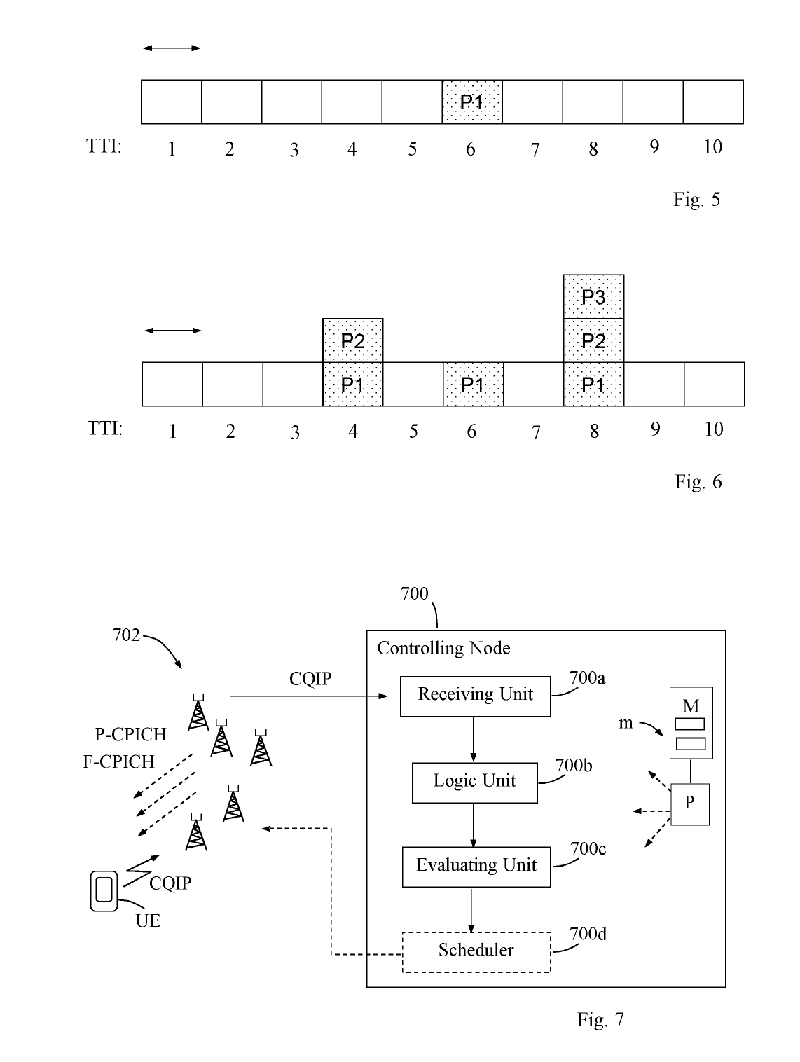

FIGS. 5 and 6 illustrate examples of how node-specific demodulation pilots may be transmitted from radio nodes of a combined cell within a time sequence of consecutive Transmission Time Intervals, TTIs 1-10. These examples may also be valid for other types of node-specific pilot signals. In a first example, one node-specific demodulation pilot “P1” is transmitted from one of the radio nodes at a 6^{th} TTI, as shown in FIG. 5. Hence a CQI computed, i.e. determined, by a legacy UE at the 6^{th} TTI will be impacted, i.e. corrupted, due to interference caused by the transmission of P1. Similarly in the second example shown in FIG. 6, node-specific demodulation pilots P1, P2 and P3 are transmitted from individual radio nodes during the 4^{th} TTI, 6^{th} TTI and 8th TTI, as indicated in FIG. 6. Hence the CQI computed by the legacy UE during these TTIs will be likewise impacted due to interference caused by the transmissions of P1, P2 and P3, respectively.

A detailed but non-limiting example of how a controlling node of a cellular network for wireless communication may be structured with some possible functional units to bring about the above-described functionality of the controlling node, is illustrated by the block diagram in FIG. 7. In this figure, the controlling node 700 is arranged to control radio communication over a radio link used by a UE to communicate radio signals with multiple radio nodes 702 serving a combined cell in the cellular network. The controlling node 700 may be configured to operate according to any of the examples and embodiments of employing the solution as described above and as follows.

The controlling node 700 comprises a receiving unit 700a which is configured to receive from the UE a CQI, such as CQIP as shown here, that has been determined by the UE based on a common pilot signal, such as P-CPICH as shown here, that is transmitted by the multiple radio nodes 702 of the combined cell as indicated by the dashed arrows. In practice, one or more of the radio nodes 702 receives the CQI transmitted by the UE and forwards it to the controlling node 700 over an existing communication interface between the radio nodes 702 and the controlling node 700.

The controlling node 700 also comprises a logic unit 700b which is configured to detect that the received CQI has been determined by the UE during a time interval when one or more node-specific pilot signals, here indicated as F-CPICH, were also transmitted individually by one or more of the multiple radio nodes 702 in the combined cell, likewise indicated by the dashed arrows. This detection may be made according to the above description of any of actions 204, 302 and 402. The logic unit 700b is also configured to change the received CQI to compensate for interference caused by the one or more node-specific pilot signals on the common pilot signal when received by the UE, e.g. according to the above description of any of actions 206, 306 and 406.

The controlling node 700 also comprises an evaluating unit 700c which is configured to use the changed CQI for evaluating the radio link, e.g. according to the above description of any of actions 208, 308 and 408. For example, the evaluation of the radio link may be used by a scheduling function, schematically indicated as scheduler 700d, for scheduling transmissions over the radio link to or from one or more of the radio nodes 702, as indicated by the dashed arrow from scheduler 700d. Further examples of using a changed CQI and such evaluation of a radio link have been described above.

The above controlling node 700 and its functional units may be configured or arranged to operate according to various optional embodiments. In a possible embodiment, the logic unit 700b may be configured to change the received CQI by replacing the received CQI by a previously received CQI that the UE has determined during a time interval when no node-specific pilot signal was transmitted in the combined cell, e.g. according to the above description of action 306

In another possible embodiment, the logic unit 700b may alternatively or additionally be configured to change the received CQI by computing an adjusted CQI “CQI_adjusted” based on the received CQI “CQI_R” and a path loss “PLⱼ” of each radio node j in the combined cell, and replacing the received CQI by the adjusted CQI, e.g. according to the above description of action 406. It has been described above in more detail in connection with action 406 how the adjusted CQI may be computed in practice.

In further possible embodiments, the logic unit 700b may be configured to change the received CQI by replacing the received CQI by a previously received CQI when a current speed of the UE is below a threshold, or by computing an adjusted CQI as described above when the current speed of the UE is not below the threshold. These latter embodiments will be further described later below with reference to FIG. 14.

It should be noted that FIG. 7 illustrates some possible functional units in the controlling node 700 and the skilled person is able to implement these functional units in practice using suitable software and hardware. Thus, the solution is generally not limited to the shown structures of the controlling node 700, and the functional units 700a-c may be configured to operate according to any of the features described in this disclosure, where appropriate.

The embodiments and features described herein may be implemented in a computer program comprising computer readable code which, when run on a controlling node, causes the controlling node to perform the above actions e.g. as described for FIGS. 2 to 4. Further, the above-described embodiments may be implemented in a computer program product comprising a computer readable medium on which a computer program is stored. The computer program product may be a compact disc or other carrier suitable for holding the computer program. The computer program comprises computer readable code which, when run on the controlling node 700, causes the controlling node 700 to perform the above actions. Some examples of how the computer program and computer program product can be realized in practice are outlined below.

The functional units 700a-c described above for FIG. 7 may be implemented in the controlling node 700 by means of program modules of a respective computer program comprising code means which, when run by a processor “P” causes the controlling node 700 to perform the above-described actions and procedures. The processor P may comprise a single Central Processing Unit (CPU), or could comprise two or more processing units. For example, the processor P may include a general purpose microprocessor, an instruction set processor and/or related chips sets and/or a special purpose microprocessor such as an Application Specific Integrated Circuit (ASIC). The processor P may also comprise a storage for caching purposes.

Each computer program may be carried by a computer program product in the controlling node 700 in the form of a memory “M” having a computer readable medium and being connected to the processor P. The computer program product or memory M thus comprises a computer readable medium on which the computer program is stored e.g. in the form of computer program modules “m”. For example, the memory M may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the controlling node 700.

In the following sections, various aspects and circumstances related to usage of a combined cell will be discussed which may be taken into consideration when employing any of the embodiments described above.

In recent years, operators of cellular networks have started to offer mobile broadband services based on Wideband Code Division Multiple Access/High Speed Packet Access, WCDMA/HSPA. Further, fueled by new devices, such as smartphones and tablets which are designed for data applications with high data rates, the end user requirements for performance and capacity are steadily increasing. The large uptake of mobile broadband has resulted in that the traffic volumes that need to be handled by the HSPA networks have grown significantly. Therefore, techniques that allow cellular operators to manage their spectrum resources more efficiently are highly desirable. In this context, the above-described embodiments might be useful to implement so as to enable better capacity and performance in the network.

Examples of techniques whereby it is possible to improve downlink performance and data rates would be to introduce support for 4-branch MIMO, multiflow communication, multi carrier deployment, etc. Since improvements in spectral efficiency per radio link are approaching theoretical limits, the next generation technology is aiming to improve the spectral efficiency per unit area. In other words, the additional features for HSDPA need to provide a high area capacity as well as increased user performance; both for a typical user and for cell-edge users. Currently, the Third Generation Partnership Project 3GPP has been working on this aspect of using Heterogeneous networks, see e.g. the following 3GPP documents: RP-121436 “Study on UMTS Heterogeneous Networks”, R1-124512 “Initial considerations on Heterogeneous Networks for UMTS”, and R1-124513, “Heterogeneous Network Deployment Scenarios”.

In heterogeneous networks, in addition to the planned or regular placement of macro nodes or base stations, several LPNs such as pico/femto/relay nodes or base stations may be deployed, e.g. as shown in FIG. 1. As mentioned above, the power transmitted by these pico/femto/relay nodes or base stations, i.e. LPNs, is relatively small compared to that of macro nodes or base stations, e.g., 2 W as compared to 40 W for a typical macro base station. The LPNs may be deployed e.g. to eliminate coverage holes in a homogeneous network using macro only, and/or to improve performance at high loads and enhance capacity, e.g., in traffic hot-spots. Due to their lower transmit power and smaller physical size, the LPNs such as pico/femto/relay base stations are able to offer flexible site acquisitions.

As explained above, heterogeneous networks can be divided into two categories, in which:
1. Low power nodes have different cell identities than the macro node, thus forming multiple individual cells, hence the above-described co-channel deployment.
2. Low power nodes have the same cell identity as that of the macro node, thus forming a single combined cell, hence the above-described combined cell deployment.

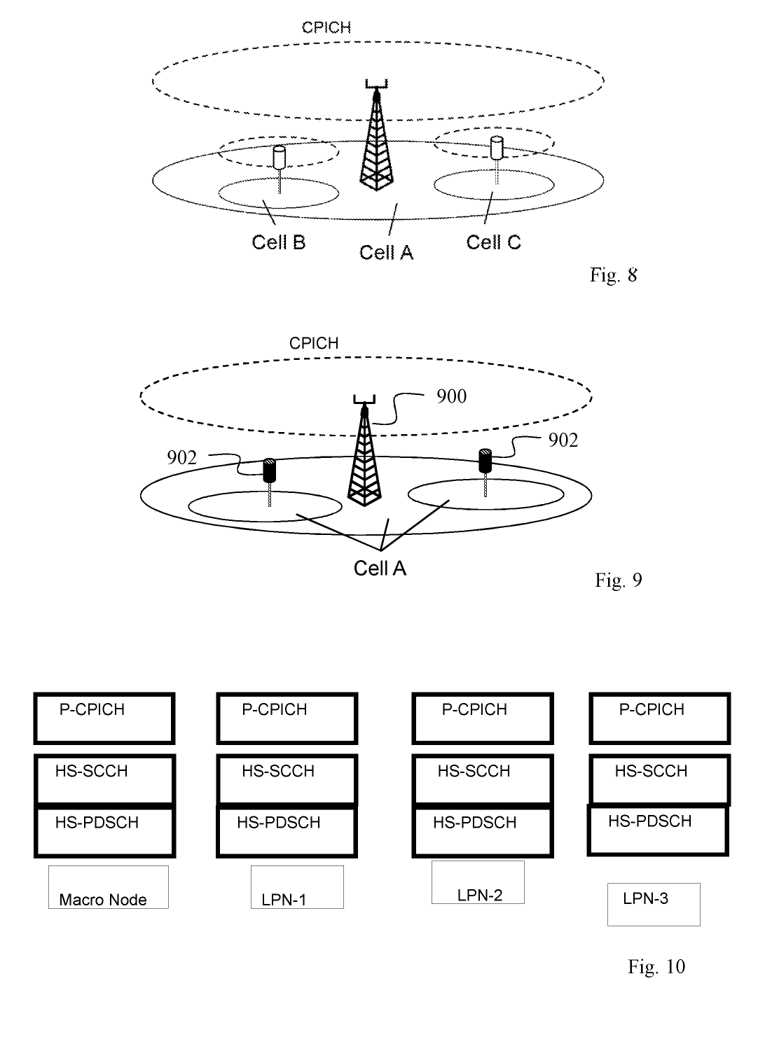

FIG. 8 illustrates schematically a heterogeneous network where low power nodes create different cells B and C within a cell A covered by a macro node. Simulations have proved that using LPNs in a macro cell will offload the macro node in terms of traffic, and the area splitting provided by the LPNs may further result in improvements in terms of system throughput as well as throughput for UEs located close to the macro cell edge.

A disadvantage of the network of FIG. 8 is that each LPN creates a different cell, as also discussed above, such that a UE needs to perform handover, e.g. soft handover, when moving between cells, e.g. from one LPN to the macro node or to another LPN. Hence, the number of handovers, as well as the amount of higher layer signaling needed to perform the handovers, is relatively great as compared to using a combined cell.

FIG. 9 illustrates schematically a heterogeneous network where a macro node 900 serves a macro cell A and two shown low power nodes 902 are part of the macro cell A, which cell A is thus a combined cell. This arrangement avoids the frequent soft handovers, and also the higher layer signaling required for handover. In further possible embodiments, the multiple radio nodes in the combined cell of this solution may thus comprise a macro node 900 transmitting with a relatively high power and a set of low power nodes 902 transmitting with a relatively low power, and wherein the controlling node described herein may be associated with the macro node 900.

Some commonly used Transmission Modes in a Combined Cell Deployment will now be described. Based on the data transmission from different nodes, the transmission modes in a combined cell deployment may be divided into:

a) Single Frequency Network: In this mode, denoted “SFN mode”, all radio nodes transmit the same pilot channel, commonly called the “primary common pilot, P-CPICH”, and also the same data and control information is transmitted from all the nodes. Note that in this case only one UE can be served from all the nodes at any time interval. Hence this mode may be useful for improving coverage. Furthermore, this mode can be used when serving legacy UEs which are capable of receiving and decoding the P-CPICH. FIG. 10 shows how different radio nodes of a combined cell may transmit signals in the SFN mode. The radio nodes of the combined cell in this example include a macro node and three low power nodes LPN-1, LPN-2 and LPN-3, all transmitting the same P-CPICH. This figure also illustrates that the radio nodes transmit a High Speed Shared Control Channel, HS-SCCH and a High Speed Physical Downlink Shared Channel, HS-PDSCH. The above-described embodiments may not be necessary to employ in this scenario since no node-specific pilot signals occur.

b) Node Selection with Spatial Re-use: In this mode, all the radio nodes of a combined cell transmit the same pilot channel, but data and the control information transmitted from one radio node is different from that transmitted from all other radio nodes, or from at least one of the radio nodes, i.e. one or more radio nodes will be serving a specific UE, while at the same time different data and control channel information will be sent to another different UE. Hence the spatial resources can effectively be reused. This mode may be used to achieve load balancing gains, hence the capacity of the combined cell can be increased significantly. FIG. 11 illustrates how four radio nodes 1-4 transmit the same common pilot signal denoted P-CPICH but different node-specific pilot signals, here denoted D-CPICH 1-4, as well as other node-specific control information denoted HS-SCCH 1-4 and HS-PDSCH 1-4, thereby enabling spatial re-use. The same common pilot signal P-CPICH transmitted by all nodes is sometimes also referred to as the “combined P-CPICH”. The above-described embodiments may be useful to employ in this scenario since the node-specific pilot signals D-CPICH 1-4 occur.

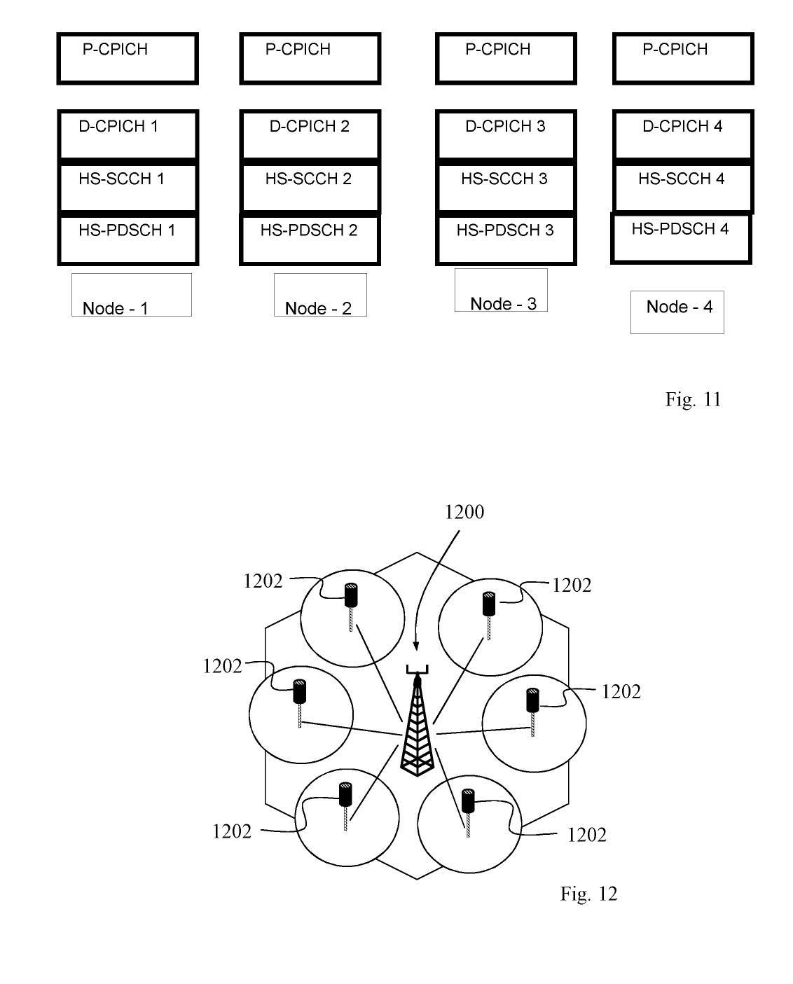

FIG. 12 shows a typical configuration of a combined cell deployment where a central controller 1200 of a combined cell, i.e. the above-described controlling node, is responsible for collecting various operational statistics information of network environment measurements from different radio nodes 1202. The decision of which radio nodes to transmit to a specific UE is made by the central controller 1200 based on the information provided by the UE, or on its own. The cooperation among various radio nodes 1202 is determined and instructed by the central controlling node which is basically implemented in a centralized way, e.g. in a macro node or in a separate node connected to the radio nodes. Thus, the central controller 1200 illustrated here may operate according to any of the embodiments described herein, thus operating as the controlling node according to any of FIGS. 2-4 and 7.

It will now be described how additional pilots may be used for supporting the above-described spatial re-use mode in a combined cell. Additional pilots may be useful in a combined cell for mainly two purposes:

1. Identifying which Radio Node is More Suitable for a Particular UE

In a combined cell deployment, all the radio nodes of the combined cell may transmit the same common pilot P-CPICH, as described above, and the UE is able to determine, or compute, the CQI based on the combined pilots. Hence the central controlling node does not know where the UE is located or which radio nodes should transmit data to this particular UE. This is similar to cell selection in co-channel deployment, where the UE compares the pilot strengths of each radio node and decide which cell is more suitable. Since all the radio nodes in a combined cell have the same primary scrambling code, the UE may not be able to distinguish between individual pilots transmitted from different radio nodes, e.g. in case the UE is a legacy or pre-12 UE as described above.

2. Data Demodulation

In the combined cell, the UE is receiving pilot signals from all the radio nodes for CQI for channel sounding, i.e. CQI computation, while data may be transmitted from only one radio node or from a subset of the radio nodes. Hence the channel estimation for data demodulation may be corrupted if the UE uses channel estimation from the combined P-CPICH. Hence for estimating the channel for data demodulation, additional pilots are needed.

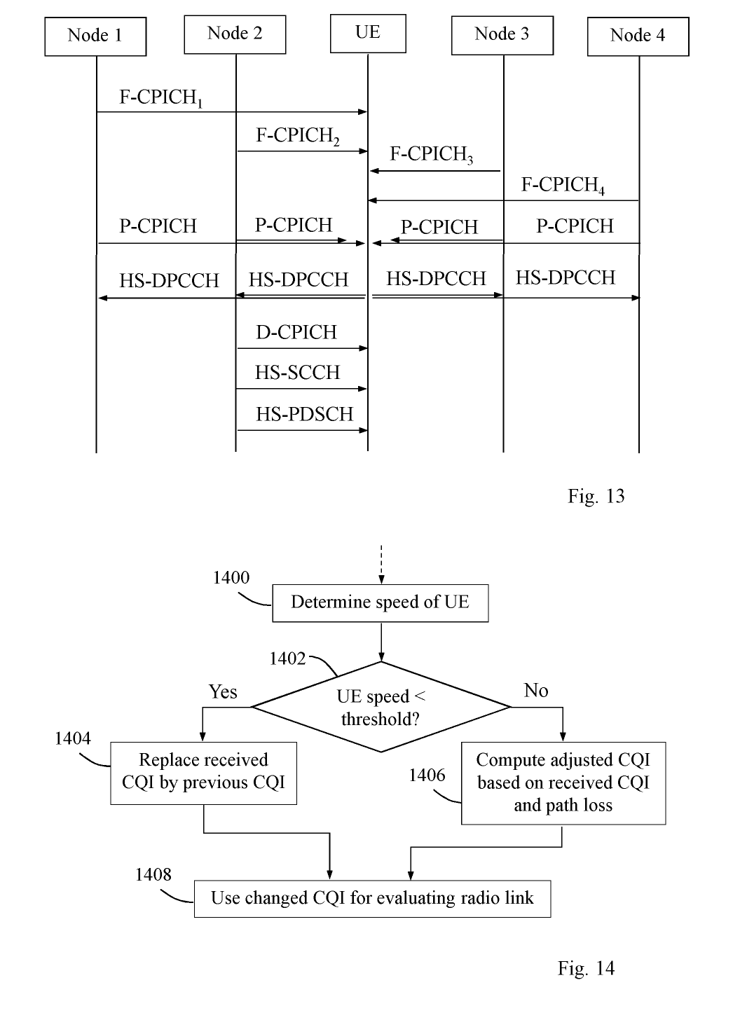

It will now be described how a message sequence chart may be employed in a Combined Cell in the Spatial Reuse Mode. FIG. 13 illustrates a message sequence chart that may be employed when implementing any of the above-described embodiments. It is assumed that a combined cell deployment involves 4 radio nodes serving multiple UEs, including the UE shown here. It should be noted that the same procedure is applicable also when the number of radio nodes is more than 4 or less than 4.

A reference signal which is unique to each radio node in a combined cell, i.e. the above-described node-specific pilot signal, such as F-CPICH, is transmitted from each node simultaneously and continuously, denoted as F-CPICH₁, F-CPICH₂, F-CPICH₃, and F-CPICH₄, respectively. The F-CPICH is characterized by a Spreading Code SF, typically SF=256, and a scrambling code which is either a primary scrambling code or a secondary scrambling code of the combined cell. The F-CPICH channel power levels may be indicated to the UE during initial cell set up.

In addition to the node-specific pilots F-CPICH, the primary common pilot P-CPICH, which reference signal is common to all the radio nodes, is continuously transmitted by all radio nodes of the combined cell and may be received by the UE as shown. From these two different pilot signals F-CPICH and P-CPICH, the UE estimates the channel and feeds back, i.e. reports, the channel quality information CQI associated with these two pilots at two time intervals. Note that the CQI estimated with a node-specific pilot signal F-CPICH indicates the channel quality corresponds to the specific radio node, referred to hereafter as “CQIF”, and a CQI computed using the primary common pilot P-CPICH indicates the channel quality using the combined nodes, referred to hereafter as “CQIP”. These two CQIs, CQIF and CQIP, are time multiplexed and sent from the UE on the uplink feedback channel HS-DPCCH, as shown in the figure. The same HS-DPCCH signal is received by all the radio nodes 1-4. A central processing unit in the controlling node, not shown, processes the received signal HS-DPCCH from all the radio nodes.

From the CQIF, a scheduler in the central controlling node is able to identify which radio node the UE is close to. Hence the scheduler informs the respective radio node to transmit to the UE. The assigned radio node, radio node 2 in this example, transmits the demodulation pilot channel D-CPICH, a downlink control channel HS-SCCH and a downlink traffic channel HS-PDSCH to the respective UE. Similarly, the central scheduler may inform the other radio nodes to transmit to other UEs, if any. In could be noted that D-CPICH and F-CPICH use different spreading codes and may be transmitted with different power levels. For example, the power level of F-CPICH may be relatively low and the power level of D-CPICH may be relatively high.

In general, it is common for cellular networks to operate in SFN mode whenever there are legacy UEs present in the combined cell. The network may thus be configured to switch between operating in the SFN mode and in the spatial reuse mode depending on whether any legacy UEs are present or not. However, this is not necessary if the solution described herein is employed. Note that a legacy UE needs to report CQI either every TTI, or a reporting period may be configured by a Radio Network Controller, RNC, or the like. There might be instances when the legacy UE computes the CQI at the same time when there might be transmissions to Release-12 UEs, i.e. non-legacy UEs, from one or more radio nodes. While during data transmission to a legacy UE in any TTI, all these demodulation pilots need to be switched off. Hence the CQI computed by the legacy UE is always pessimistic. Hence the link, or system, throughput of the legacy UEs would be reduced unless the solution described herein is employed.

Some embodiments have been described above where the reported CQI may be adjusted by using two alternative procedures, denoted examples 1 and 2, as illustrated by FIGS. 3 and 4, respectively. It was also mentioned above that the controlling node may select one of the above two procedures depending on a current speed of the UE, which will now be described in more detail.

It may be noted that the procedure of example 1 is relatively straightforward to implement as this method does not require computation of an adjusted CQI value which in turn may need computation of the path loss from each radio node, e.g. as described above for action 406. On the other hand, the procedure of example 2 is more accurate but requires additional computations. However, to avoid any unnecessary computations the central node may choose to employ a procedure according to either example 1 or example 2 above based on the UE speed. It is assumed that if the UE is moving slowly or not at all, the CQI does not change, at least not significantly, and example 1 can be employed. Hence, the previously reported CQI may be considered valid in this context when there are no node-specific pilots transmitted from any node, while for a high speed UE the previously reported CQI of example 1 may not be valid as the CQI might change when no node-specific pilots are transmitted.

FIG. 14 illustrates an example of how the above-described controlling node may operate in more detail when performing the above action 206 of changing the received CQI depending on UE speed. It is thus assumed that actions 200-204 of FIG. 2 have been executed before the procedure of FIG. 14, which is indicated by a dashed arrow. In a first shown action 1400, the controlling node obtains a current speed of the UE which may be done in different ways, without limitation to these embodiments. For example, a channel estimate may be computed over a period of time based on uplink signals from the UE, and a rate change of the channel estimates may be computed over the period of time. The rate change of the channel estimates may be called a “Doppler Metric”, DM which can be used as an indication of the UE speed. However, any other method, known in the art, could be used for determining or obtaining the UE speed, e.g. in the form of a suitable indication thereof, and these embodiments are not limited in this respect.

In a next action 1402, the controlling node determines whether the UE speed, e.g. represented by the above DM, is below a certain threshold value or not. If so, the controlling node employs the above example 1 for changing the CQI and replaces the received CQI by a previous CQI, as of action 1404. On the other hand, if the UE speed is not below the threshold in action 1402, the controlling node employs instead the above example 2 for changing the CQI and computes an adjusted CQI based on the received CQI and a path loss of each radio node in the combined cell, as of action 1406, which may be done in the manner described for action 406 above. The controlling node finally uses the changed CQI for evaluating the radio link, in an action 1408, which corresponds to action 208 above.

Some potential advantages that may be achieved by implementing the solution according to any of the embodiments described herein thus include that performance and throughput for serving legacy UEs in a combined cell can be maintained or improved even when node-specific pilot signals are employed, as compared to previous solutions and procedures. The impact of the node-specific pilot signals on throughput for legacy UEs can thus be minimized by adjusting the reported CQI to a more justified value in the manner described above when it is detected that the received CQI has been determined when one or more node-specific pilot signals were also transmitted.

While the solution has been described with reference to specific exemplary embodiments, the description is generally only intended to illustrate the inventive concept and should not be taken as limiting the scope of the solution. For example, the terms “radio node”, “User Equipment, UE”, “controlling node”, “combined cell”, “legacy UE”, “non-legacy UE”, “common pilot signal” and “node-specific pilot signal” have been used throughout this description, although any other corresponding entities, functions, and/or parameters could also be used having the features and characteristics described here.

Abbreviations
CQI Channel Quality Indicator
CPICH Common Pilot Channel
D-CPICH Demodulation CPICH
DPCCH Dedicated Physical Control Channel
HS-DPCCH High Speed DPCCH
HSPA High Speed Packet Access
LPN Low Power Node
MIMO Multiple Input Multiple Output
OFDM Orthogonal Frequency Division Multiplex
P-CPICH Primary CPICH
F-CPICH Fractionary CPICH
PDCCH Physical Downlink Control Channel
HS-SCCH High Speed Shared Control Channel
HS-PDSCH High Speed Physical Downlink Shared Channel
SFN Single Frequency Network
TTI Transmission Time Interval
UE User Equipment
WCDMA Wideband Code Division Multiple Access
3GPP Third Generation Partnership Project

1-20. (canceled)

21. A method, performed by a controlling node of a cellular network for wireless communication, to control radio communication over a radio link used by a User Equipment (UE) to communicate radio signals with multiple radio nodes serving a combined cell in the cellular network, the method comprising:
receiving a Channel Quality Indicator (CQI) that has been determined by the UE based on a common pilot signal transmitted by the multiple radio nodes of the combined cell;
detecting that the received CQI has been determined by the UE during a time interval when one or more node-specific pilot signals were also transmitted individually by one or more of the multiple radio nodes in the combined cell;
changing the received CQI to compensate for interference caused by the one or more node-specific pilot signals on the common pilot signal when received by the UE; and
using the changed CQI for evaluating the radio link.

22. The method according to claim 21, wherein changing the received CQI comprises replacing the received CQI by a previously received CQI that the UE has determined during a time interval when no node-specific pilot signal was transmitted in the combined cell.

23. The method according to claim 21, wherein changing the received CQI comprises computing an adjusted CQI based on the received CQI and a path loss of each of the multiple radio nodes in the combined cell, and replacing the received CQI by the adjusted CQI.

24. The method according to claim 23, wherein the adjusted CQI (CQI_adjusted) is computed as:
CQI_adjusted= [symbol] (G(CQI_R) dB−Σxj(PLj)dB),
where CQI_R is the received CQI, PLj is the path loss for the j-th radio node, G and [symbol] are inverse functions, the summation Σ goes from j=1 to Np being the total number of the multiple radio nodes in the combined cell, and xj is a binary variable, and where xj is equal to 1 when the node-specific pilot signal is switched on by the radio node j during the CQI determination period and xj is equal to 0 when the node-specific pilot signal is switched off by the radio node j during the CQI determination period.

25. The method according to claim 21, wherein, when a current speed of the UE is below a threshold, the received CQI is changed by replacing the received CQI by a previously received CQI, and otherwise the received CQI is changed by replacing the received CQI with an adjusted CQI that is computed based on the received CQI and a path loss of each of the multiple radio nodes in the combined cell.

26. The method according to claim 21, wherein the one or more node-specific pilot signals comprise a node-specific demodulation pilot.

27. The method according to claim 21, wherein the UE is a legacy UE capable of determining CQI based on the common pilot signal but not based on the one or more node-specific pilot signals.

28. The method according to claim 21, wherein the one or more node-specific pilot signals are transmitted in the combined cell to enable non-legacy UEs to determine one or more node-specific CQIs based on the one or more node-specific pilot signals.

29. The method according to claim 21, wherein the common pilot signal comprises a primary Common Pilot Channel (CPICH) and the one or more node-specific pilot signals comprise a fractional CPICH.

30. The method according to claim 21, wherein the multiple radio nodes in the combined cell comprise a macro node transmitting with a relatively high power and a set of low power nodes transmitting with a relatively low power, and wherein the controlling node is associated with the macro node.

31. A controlling node of a cellular network for wireless communication, the controlling node being arranged to control radio communication over a radio link used by a User Equipment (UE) to communicate radio signals with multiple radio nodes serving a combined cell in the cellular network, the controlling node comprising:
communication interface circuitry configured to receive a Channel Quality Indicator (CQI) that has been determined by the UE based on a common pilot signal transmitted by the multiple radio nodes of the combined cell; and
processing circuitry configured to:
detect that the received CQI has been determined by the UE during a time interval when one or more node-specific pilot signals were also transmitted individually by one or more of the multiple radio nodes in the combined cell;
change the received CQI to compensate for interference caused by the one or more node-specific pilot signals on the common pilot signal when received by the UE; and
use the changed CQI for evaluating the radio link.

32. The controlling node according to claim 31, wherein the processing circuitry is configured to change the received CQI by replacing the received CQI by a previously received CQI that the UE has determined during a time interval when no node-specific pilot signal was transmitted in the combined cell.

33. The controlling node according to claim 31, wherein the processing circuitry is configured to change the received CQI by computing an adjusted CQI, based on the received CQI and a path loss of each radio node j in the combined cell, and replacing the received CQI by the adjusted CQI.

34. The controlling node according to claim 33, wherein the adjusted CQI (CQI adjusted) is computed as:
CQI_adjusted= [symbol] (G(CQI_R) dB−Σxj(PLj)dB)
where G and [symbol] are inverse functions, PLj is the path loss for the j-th radio node, the summation Σ goes from j=1 to Np being the total number of the multiple radio nodes in the combined cell, and xj is a binary variable, and wherein xj is equal to 1 when the node-specific pilot signal is switched on by the radio node j during the CQI determination period and xj is equal to 0 when the node-specific pilot signal is switched off by the radio node j during the CQI determination period.

35. The controlling node according to claim 31, wherein the processing circuitry is configured to change the received CQI by replacing the received CQI with a previously received CQI, when a current speed of the UE is below a threshold, and otherwise by replacing the received CQI with an adjusted CQI computed based on the received CQI and a path loss of each of the multiple radio nodes.

36. The controlling node according to claim 31, wherein the one or more node-specific pilot signals comprise a node-specific demodulation pilot.

37. The controlling node according to claim 31, wherein the UE is a legacy UE capable of determining CQI based on the common pilot signal but not based on the one or more node-specific pilot signals.

38. The controlling node according to claim 31, wherein the one or more node-specific pilot signals are transmitted in the combined cell to enable non-legacy UEs to determine one or more node-specific CQIs based on the one or more node-specific pilot signals.

39. The controlling node according to claim 31, wherein the common pilot signal comprises a primary Common Pilot Channel (CPICH) and the one or more node-specific pilot signals comprise a fractional CPICH.

40. The controlling node according to claim 31, wherein the multiple radio nodes in the combined cell comprise a macro node transmitting with a relatively high power and a set of low power nodes transmitting with a relatively low power, and wherein the controlling node is associated with the macro node.
